(19) United States
(12) Patent Application Publication
(10) Pub. No.: US 2017/0034720 A1
(43) Pub. Date: Feb. 2, 2017

(54) Predicting Network Performance

(71) Applicant: Futurewei Technologies, Inc., Plano, TX (US)

(72) Inventors: Nandu Gopalakrishnan, Chatham, NJ (US); Jin Yang, Bridgewater, NJ (US); Juan Roa, Hillsborough, NJ (US); James Mathew, Belle Mead, NJ (US); Baoling S. Sheen, Naperville, IL (US); Yong Ren, Jersey City, NJ (US)

(21) Appl. No.: 14/810,699

(22) Filed: Jul. 28, 2015

(51) Int. Cl. H04W 24/08; H04W 16/18; H04W 24/10

(52) U.S. Cl. CPC H04W 24/08; H04W 24/10; H04W 16/18

(57) ABSTRACT

Methods and systems for predicting network performance include receiving a number of sets of data points of a number of network elements. Each of the number of sets of data points includes performance counter values and a performance indicator of a respective network element of the number of network elements. A global model representing a global relationship pattern between the performance indicator and the performance counter values is determined based on the number of sets of data points of the number of network elements. For each network element, residual features are determined based on error measures between the global model and the set of data points including the performance indicator and the performance counter values of the network element. The number of network elements are clustered into a number of clusters based on the determined residual features of the number of network elements.

### BACKGROUND

Network Key Performance Indicators (KPIs), such as access setup success rate, call drop rate, Received Total Wideband Power (RTWP), etc., reflect the quality of the network and, thus, are closely monitored by network operators. It is desirable for network operators to forecast a network's KPIs before any network changes take place, e.g., adding new carriers, subscribers, applications, devices, etc. However, predicting network KPIs is not a straightforward task because KPI is usually impacted by a lot of variables. For example, KPIs can be impacted by the traffic amount of the network that is relatively easier to estimate, coverage and interference parameters that usually require analysis from User Equipment (UE) Measurement Reports (MRs), to UE distribution and behavior which may or may not be available even if call data records are collected.

Grouping or clustering similar network elements (e.g., cells) is a typical first step for predicting KPIs. Clustering includes grouping a set of cells in such a way that cells in the same group (referred to as a cluster) are more similar (in some sense or another) to each other than to those in other groups (clusters). The grouping or clustering cells is critical as the quality of the clustering result directly impacts the accuracy of KPI prediction. Common telecommunication clustering practice groups network elements (e.g., cells) based on cell physics selected according to engineering experience. Typical selected cell physics parameters include, for example, configuration parameters (Maximum Transmit Power, antenna height or tilt, Maximum number of UEs allowed, High-Speed Downlink Packet Access (HSDPA)/High-Speed Uplink Packet Access (HSUPA) allowed, etc.), Cell Engineering Parameters (Inter-Site Distance, Cell Type, etc.), and Interference and Coverage characteristics (segmented RSCP, EcNo reported by the UEs via MR's).

### SUMMARY

The present disclosure involves systems, software, and computer-implemented methods for predicting network performance.

In general, one aspect of the subject matter described here can be implemented as a method performed by a processing apparatus. The method includes receiving, by operation of the processing apparatus, a number of sets of data points of a number of network elements, each of the number of sets of data points corresponding to a respective network element of the number of network elements, the set of data points comprising performance counter values and a performance indicator of the respective network element; determining a global model representing a global relationship pattern between the performance indicator and the performance counter values based on the number of sets of data points of the number of network elements; for each network element of the number of network elements, determining one or more residual features, the one or more residual features based on error measures between the global model and the set of data points including the performance indicator and the performance counter values of the network element; and clustering the number of network elements into a number of clusters based on the determined one or more residual features of the number of network elements.

In some instances, one aspect of the subject matter described here can be implemented as a computing system. The computing system includes a memory storing programming and a processor interoperably coupled with the memory and, when executing the programming, the computing system is configured to receive a number of sets of data points of a number of network elements, each of the number of sets of data points corresponding to a respective network element of the number of network elements, the set of data points comprising performance counter values and a performance indicator of the respective network element; determine a global model representing a global relationship pattern between the performance indicator and the performance counter values based on the number of sets of data points of the number of network elements; for each network element of the number of network elements, determine one or more residual features, the one or more residual features based on error measures between the global model and the set of data points including the performance indicator and the performance counter values of the network element; and cluster the number of network elements into a number of clusters based on the determined one or more residual features of the number of network elements.

In some instances, one aspect of the subject matter described here can be implemented as a non-transitory, computer-readable medium storing computer-readable instructions executable by a computer and configured to perform operations. The operations include receiving a number of sets of data points of a number of network elements, each of the number of sets of data points corresponding to a respective network element of the number of network elements, the set of data points comprising performance counter values and a performance indicator of the respective network element; determining a global model representing a global relationship pattern between the performance indicator and the performance counter values based on the number of sets of data points of the number of network elements; for each network element of the number of network elements, determining one or more residual features, the one or more residual features based on error measures between the global model and the set of data points including the performance indicator and the performance counter values of the network element; and clustering the number of network elements into a number of clusters based on the determined one or more residual features of the number of network elements.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 is a block diagram showing an example system configured to perform performance behavior-based clustering techniques.

FIG. 2 is a block diagram showing aspects of example performance behavior-based clustering techniques.

FIG. 3 is a flowchart illustrating an example process for predicting network performance.

FIG. 4 is a diagram showing example feature selection results based on clusters determined from example performance behavior-based clustering techniques.

FIG. 5A is a plot showing example predicted KPI values versus actual KPI values based on a baseline approach of linear regression without clustering.

FIG. 5B is a plot showing example predicted KPI values versus actual KPI values using cell physics-based clustering.

FIG. 5C is a plot showing example predicted KPI values versus actual KPI values using performance behavior-based clustering.

Like reference numbers and designations in the various drawings indicate like elements.

### DETAILED DESCRIPTION

In some aspects, systems, software, and computer-implemented methods for predicting network performance are described. Example techniques described herein include mechanisms for grouping or clustering network elements (NEs, e.g., cells or Base Transceiver Stations (BTSs)) based on their performance behavior patterns. The example clustering techniques are referred to as performance behavior-based clustering throughout this disclosure.

The example performance behavior-based clustering techniques can group cells with similar Key Performance Indicators (KPI) behavior patterns together, without requiring the knowledge of the cell physics parameters. A KPI is a metric of the performance of essential operations and/or processes of a NE. A KPI can keep track and indicate the availability and performance of the network infrastructure. Example KPIs of a network element include access setup/handover success rate, call drop rate, Received Total Wideband Power (RTWP), uplink/downlink throughput, and network access delay.

In some implementations, the example performance behavior-based clustering techniques use only network performance counter values to forecast KPI values, without requiring User Equipment (UE) Measurement Reports (MRs) or Call History Records (CHRs). In some implementations, NEs' performance patterns are learned via regression, for example, by modeling the relationship between one or more KPIs and one or more performance counter values of the NEs, such as traffic and/or resource attributes. Although the example performance behavior-based clustering techniques do not use coverage, interference, UE distribution, and behavior variables in the modeling explicitly, the example techniques treat these variables as hidden variables so their impacts to network performance can be reflected in the learned performance patterns. Based on the regression result, the residual distribution statistics can be determined and used as features to feed into one or more clustering algorithms to group the NEs.

In some implementations, the example techniques for predicting network performance include another layer of clustering performed prior to performing performance behavior-based clustering of the NEs. The pre-clustering is referred to as super-clustering in this disclosure. The super-clustering can divide a number of NEs into one or more super-clusters or supersets based on attributes that are typically obtained from UE MRs or CHRs, e.g., coverage, interference, device issues (e.g., behavior of operation systems, UE mobility, or other features of the devices). Then, the performance behavior-based clustering can be performed for NEs in each super-cluster respectively.

Furthermore, example techniques are described for identifying relative influential or relevant cell physics features that explain NE's performance behavior. These identified cell physics features can be used by traditional cell physics-based clustering and improve the prediction accuracy of the cell physics-based clustering.

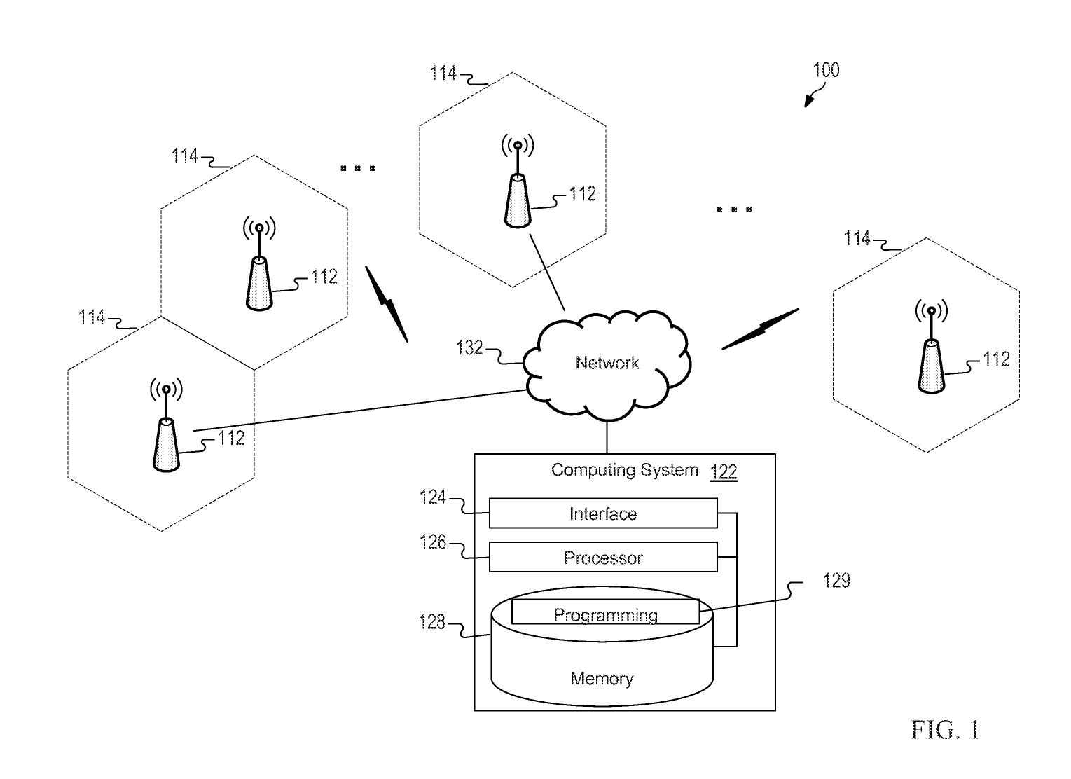

FIG. 1 is a block diagram showing an example communication system 100 configured to perform performance behavior-based clustering techniques. The example communication system 100 includes a communication network 132, a number of network elements (NEs) 112, with the NEs 112 being communicatively coupled to the communication network 132, and a computing system 122 communicatively coupled to the communication network 132. Each NE 112 is associated with a respective cell 114 of the network and can provide network services to one or more user equipments (UEs, not shown). The UE can be, for example, a mobile phone, a tablet, a computer, or another device. The NEs 112 can refer to one or more of a Base Transceiver Station (BTS)), a base station, an evolved Node B (eNB), or other type of apparatus in a communication network that can collect performance indicators or counter values of its associated network. The cells 114 comprise components of a cellular network (a macro cell network, femto cell network, etc.), wireless local access network (WLAN) network, machine-to-machine network, or other types of networks. In some instances, a cell 114 can refer to a NE 112 and its associated coverage area.

In some implementations, based on previous or concurrent performance indicators or counter values or other data of the NEs 112, future network performance of a NE (e.g., one of the NEs 112 in the communication system 100 or another NE that has similar properties to the NE in the communication system 100) can be predicted. Predicting network performance can help plan, schedule, adjust or otherwise control network deployment and maintenance of a communication network (e.g., the communication system 100).

In some implementations, the communication system 100 includes a computing system 122 that is configured to predict network performance. For example, the computing system 122 can be configured to gather performance indicators or counter values from some or all NEs 112. The computing system 122 can be a component of one of the NEs 112. In some implementations, the computing system 122 can be a central computer system dedicated to collect network performance measured from some or all NEs 112. The computing system 122 can connect to the NEs 112 through a network 132 via wireless or wireline communications.

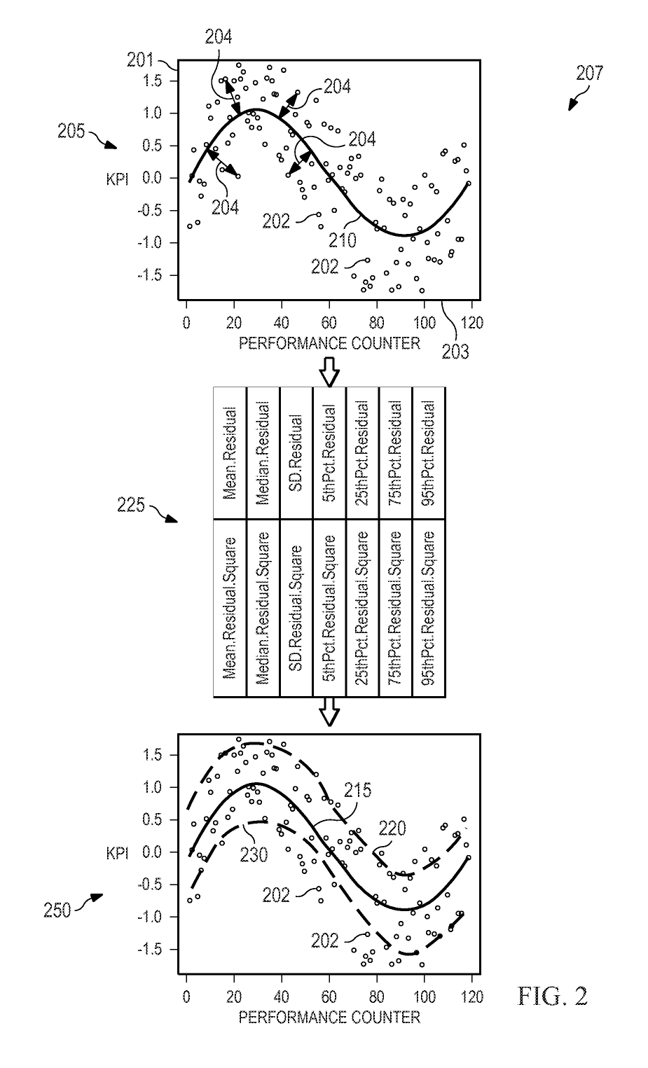

The computing system 122 can include an interface 124, a processor 126 coupled to the interface 124, and a memory 128 coupled to the processor 126. The interface 124 comprises one or more of a communication interface, a user interface, or other interface that is configured to input, output, or otherwise communicate data with a user or other device. For example, the interface can include a communication interface configured to receive measured network indicators or performance counter values from the NEs 112. The processor 126 can be a processing apparatus that can execute instructions, for example, to predict network performance. The processor 126 can be configured to perform one or more operations described with respect to FIG. 2. For example, the processor 126 can process, compute, and otherwise analyze the measured network indicators to estimate or forecast KPIs via statistical model without the MR and CHR records. In some cases, the processor 126 can execute or interpret software, scripts, programs, functions, executables, or other modules contained in the memory 128.

The memory 128 stores, among other things, programming 129. The memory 128 comprises any suitable computer-readable medium and can include, for example, a random access memory (RAM), a storage device (e.g., a writable read-only memory (ROM) or others), a hard disk, magnetic or optical media, or other storage medium. The memory 128 can store instructions (e.g., computer code) associated with operations of the computing system 122, i.e., the programming 129. The memory 128 can store, update, or otherwise manage performance counter data of the NEs 112 and other data. When the programming 129 is executed by the processor 126, the computing system 122 is configured to receive a plurality of sets of data points of a plurality of network elements 112, each of the plurality of sets of data points corresponding to a respective network element of the plurality of network elements 112, the set of data points comprising performance counter values and a performance indicator of the respective network element, determine a global model representing a global relationship pattern between the performance indicator and the performance counter values based on the plurality of sets of data points of the plurality of network elements 112, for each network element of the plurality of network elements 112, determine one or more residual features, the one or more residual features based on error measures between the global model and the set of data points comprising the performance indicator and the performance counter values of the network element, and cluster the plurality of network elements 112 into a plurality of clusters based on the determined one or more residual features of the plurality of network elements.

In some implementations, the computing system 122 can use measured network indicators as independent variables to estimate or forecast KPIs via statistical model with the absence of UE Measurement Reports (MRs) and Call History Records (CHRs). In some implementations, cells 114 with similar characteristics can have similar relationship behaviors between the cells' KPIs and the cells' traffic and/or resource attributes (referred to as traffic-resource attributes). Instead of using cell physics (e.g., inter-site distance, antenna height or tilt, raw measurement values from UE MRs or CHRs) to separate cells into clusters, the computing system 122 can use performance behavior-based clustering techniques to cluster cells based on the cells' network behavior patterns directly. KPI and traffic behavior patterns are learned via regression. Coverage, interference, UE distribution, and behavior, even though not used in the modeling explicitly, are treated as hidden variables such that their impact to network performance would be reflected in the relationship between the KPI and traffic-resource attributes.

The example techniques provide a number of advantages. For example, the example techniques can provide more accurate KPI prediction performances compared to traditional cell physics-based clustering approach. Because the cell physics parameters do not necessarily directly related to network elements' performance behavior, cell physics-based clustering approach does not guarantee accurate representation of the network elements' performance behavior. The example techniques do not depend on cell physics attributes that can be difficult and expensive to collect (e.g., from UE MRs). The example techniques can be used as a generic approach, applicable or extendable to KPIs in addition to or in alternative to the example KPIs described in this disclosure. The example techniques require no or little engineering knowledge, thus relaxing or eliminating the need to determine criteria for good/poor RF condition to group network elements which are typically used in traditional cell physics-based clustering approach. The example techniques are easy to implement, lightweight, and user-friendly. For example, the techniques can be implemented as software update in one or more NEs 112 in an existing communication system 100 without adding or changing hardware infrastructure. The example techniques may achieve additional or different advantages.

FIG. 2 is a block diagram 207 showing aspects of example performance behavior-based clustering techniques. In some implementations, a cell's individual network behavior pattern can be determined based on one or more KPIs and performance counter values of the cell. The performance counter values can include one or more traffic-resource attributes, such as a number of active users in the network, a number of traffic bytes in the network, a throughput of the network, an interference level, a downlink (DL) total transmit power level, or other types of indicators representing traffic information, coverage, and interference of the cell. Unlike UE MRs or CHRs, performance counter values are monitored and collected on a regular basis in the operator network. Thus, the performance counter values can be obtained without additional operational cost. By contrast, continuously collecting MRs (or sometimes even CHRs) will take significant system resources and is usually not permitted by the operators. Without MR or CHR records, coverage, interference, or UE-related information would usually not be available, rendering it difficult for traditional cell physics-based prediction approaches to accurately predict network KPIs.

In some implementations, a cell's one or more KPIs and the performance counter values can be included in a set of data points. For example, they can be represented, stored, and communicated as a vector, an array, a matrix, or any other data structures. In some implementations, the set of data points can span a two- or higher-dimensional space. For example, as shown in plot 205, each circle 202 represents a set of data points for a cell. In this example, the set of data points includes a KPI value (reflected by a y-axis coordinate) and a performance counter value (reflected by a x-axis coordinate) of the cell. In some implementations, the set of data points can include multiple KPI values and multiple performance counter values and can be represented in a multi-dimensional space.

In some implementations, a global regression model that represents a global relationship pattern between one or more KPIs and one or more traffic-resource attributes for all the cells can be obtained, for example, by regression. The regression can be performed based on all the sets of data points corresponding to all the cells in the same network (e.g., governed by the same Radio Network Controller (RNC) in the UMTS radio access network (UTRAN)). In some implementations, a global relationship pattern can be defined over a subset of the all the sets of data points corresponding to all the cells in the same network. The subset can be sampled or otherwise chosen to be a representative set of the overall set, for example, based on location, cell type, or other criteria to improve the computational efficiency, focus on a particular geographic region within the network, or for other purposes.

For instance, the plot 205 shows a global regression model 210 that represents the global relationship pattern between the KPI (represented by the y-axis 201) and the performance counter value (represented by the x-axis 203). In this case, the global regression model 210 can also be referred to as the global behavior curve that represents the cells' global behavior in terms of network KPI versus the performance counter values. In other instances, the global regression model 210 can be represented as a plane, a surface, a polyhedron, or other geometric objects.

The global regression model 210 can be obtained by fitting all the circles 202 using one or more regression algorithms. The regression algorithms can be selected from various existing regression algorithms. For example, the plot 205 shows a 2-dimensional (2D) KPI to performance-counter chart, and the global behavior curve 210 can be obtained via curve fitting algorithms, for example, based on different metrics (e.g., least square, minimum absolute distance, or other principles). In some implementations, the network behavior learning can be done in multiple dimensions, for example, by using multiple KPIs and performance-counter values and based on one or more multiple-dimensional regression algorithms.

The global regression model 210 can be used as a baseline to cluster the cells based on the cells' respective residual features relative to the global regression model 210. The residual features can be determined based on one or more error measures (e.g., a difference, a distance, a derivation, or other measures) of a cell's individual network behavior relative to the global regression model 210. For example, the residual features can include a distance (e.g., represented by the arrow 204) between each cell's individual network behavior (e.g., represented by the location or coordinates of the data point 202) and the global predicted behavior (e.g., represented by the global behavior curve 210).

The residual features can also include statistics of the distance feature (e.g., represented by the arrow 204) or other derived residual features. For example, table 225 in FIG. 2 shows that example residual features include the mean, median, standard deviation, 5^{th} percentile, 25^{th} percentile, 75^{th} percentile, and 95^{th} percentile of the distance features among all the cells and their respective squares. The residual features can also include additional or different features that characterize a particular cell's individual network behavior relative to the global regression model.

Based on some or all of the residual features, the cells 202 can be grouped into one or more clusters, for example, based on one or more clustering algorithms. Example clustering algorithms can include Centroid-based clustering (K-Means, K-Medoid, etc.), C-Means clustering, Expectation-Maximization clustering, Density-Based clustering, Hierarchical clustering, Affinity Propagation clustering, and other clustering algorithms.

In some implementations, within each cluster, a second level of regression can be performed based on the sets of data points corresponding to the cells in the cluster. As a result, a cluster regression model can be obtained for each cluster that represent the network behavior in terms of the KPI relative to the performance counter values for all the cells within the cluster. For example, plot 250 shows that the multiple cells 202 are grouped into three clusters and, further, that three cluster regression models 215, 220 and 230 are obtained based on the second level of regression performed for each cluster.

In some implementations, based on the cluster regression models (e.g., the cluster regression curves 215, 220 and 230), a cell's network performance can be predicted. For example, once the cell's performance counter values are identified (e.g., based on the historic, current, or estimated performance counter value data), corresponding KPI values can be pinpointed, mapped, interpolated, or otherwise calculated based on the cluster regression models. In some implementations, only a cell's historical KPIs and counter values are obtainable thus they can be used to learn its performance behavior pattern and group the cell into a cluster with other similar cells. Once a cell's cluster assignment is determined, its future KPI's can be predicted using the learned regression model for the cluster with traffic-resource parameter values which usually can be obtained from simulation or user input.

In some implementations, domain knowledge can be used to improve the accuracy of the network performance prediction. For example, KPI behaviors relative to traffic-resource attributes (e.g., based on performance counter values) for cells with coverage, interference and UE issues are typically different from cells without those issues. Distinguishing cells with these issues from cells without these issues can further improve the accuracy of the network performance prediction. In some implementations, a super clustering can be performed, prior to the performance behavior-based clustering, based on the learned or estimated domain knowledge about whether the cells have coverage, interference, or UE issues.

Example coverage issues can include the quality of its coverage, the signal strength at the cell edge, whether a cell has coverage holes in its service area, etc. Example interference issues include whether the cell suffers strong or constant neighbor cell or external interferences, etc. Example UE issues can include the types of I/O interfaces, behavior of operation systems, applications, or other problems associated with the user device. The coverage, interference and UE issues can usually be obtained by analyzing cell physics information included in a UE's MR or CHR. However, as described above, gathering sufficient MRs or CHRs may be difficult.

In some implementations, example techniques are proposed to separate cells based on a correlation between a cell's interference measurements (e.g., Received Total Wideband Power (RTWP) measurements in UMTS, a measurement for UL interference, or other interferences measurements) and traffic measurements (e.g., the number of active UEs carried by the cell, or traffic bytes carried by the cells). A cell's RTWP measurements or a measurement for UL interference can be mainly explained by or highly correlated with the traffic amount served by the cell if a cell does not suffer external or neighbor cell interference issues. Accordingly, a high correlation between cell's interference measurement and traffic characteristics likely indicates the cell does not have significant external or neighbor cell interference issues, or vice versa.

Additionally or alternatively, cells can be separated based on a correlation between a cell's call drop rate and interference measurement. For example, a cell's call drop rate is typically highly correlated with the RTWP level for cells without coverage or other device or UE behavior issues. Accordingly, a high correlation between a cell's call drop rate and RTWP likely indicates the cell has no significant coverage or UE behavior issues.

In some implementations, a super clustering can be performed prior to the performance behavior-based clustering, based on two or more of the cells' interference measurements (e.g., RTWP) traffic characteristics, and call drop rates. For example, a total number of cells can be grouped into four super-clusters. A first super-cluster includes cells with high correlations between cells' RTWP and traffic characteristics and high correlations between cells' call drop rates and RTWP, which suggests the first super-cluster of cells have no interference, nor coverage or UE behavior issues. A second super-cluster includes cells with high correlations between cells' RTWP and traffic characteristics and low correlations between cells' call drop rates and RTWP, which suggests the second super-cluster of cells have no interference issues but have coverage or UE behavior issues. A third super-cluster includes cells with low correlations between cells' RTWP and traffic characteristics and high correlations between cells' call drop rates and RTWP, which suggests the third super-cluster of cells have interference issues but no coverage or UE behavior issues. The fourth super-clusters include cells with low correlations between cells' RTWP and traffic characteristics and low correlations between cells' call drop rates and RTWP, which suggests the fourth super-cluster of cells have both interference and coverage or UE behavior issues.

In some implementations, additional or different features can be derived based on performance counter values rather than UE MRs or CHRs to represent coverage, interference, UE characteristics, or other domain knowledge of the cells. These features can be used for super clustering to further improve the predication accuracy.

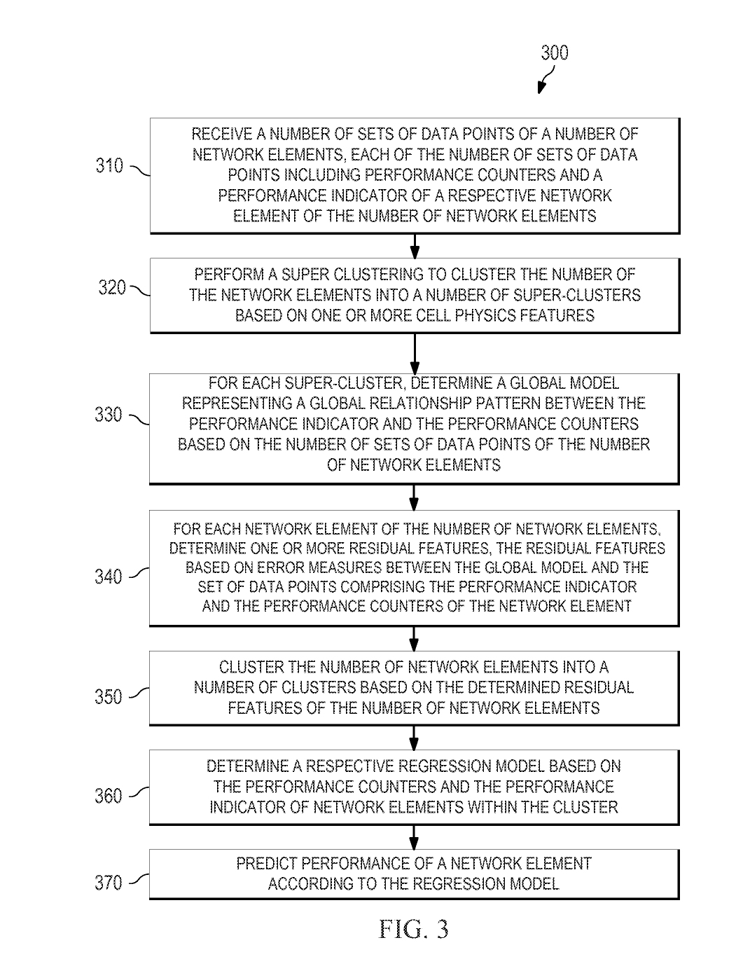

FIG. 3 is a flowchart illustrating an example process 300 for predicting network performance. The process 300 can be implemented as computer instructions stored on computer-readable media (for example, the memory 128 in FIG. 1) and executable by a processing apparatus (for example, the processor 126) of a network element in a communication network, or other computer devices separated from or independent of that communication network. In some implementations, the example process 300 can be implemented as software, hardware, firmware, or a combination thereof.

In some instances, the example process 300 can include a layered clustering process as it includes both the super clustering and performance behavior-based clustering. In some implementations, the example process 300, individual operations of the process 300, or groups of operations may be iterated (e.g., either the super clustering or the performance behavior-based clustering can be repeated so that the example process 300 evolves into a multi-layer clustering, for example, to divide the networks into finer groups). In some implementations, individual operations of the process 300 or groups of operations may be or performed simultaneously (e.g., using multiple threads). In some cases, the example process 300 may include the same, additional, fewer, or different operations performed in the same or a different order.

At 310, a number of sets of data points (e.g., data points 202 in FIG. 2) of a number of network elements (NEs, e.g., NEs 112 in FIG. 1) are received, for example, by operation of a processing apparatus (e.g., the processor 126 of a network element 112 in FIG. 1). Each set of data points corresponds to a respective network element. Each of the number of sets of data points can include performance counter values and a performance indicator (e.g., a KPI) of the respective network element of the number of network elements. The performance counter values can include one or more of a number of active users in the network, a number of traffic bytes in the network, a throughput of the network, an interference level, a downlink (DL) transmit power level, or traffic and/or resources attributes monitored and obtained regularly in the operator network, as opposed to the UE MRs or CHRs that are not continuously monitored and inconvenient to obtain.

At 320, a first layer of clustering (e.g., a super clustering) is performed by clustering the number of the network elements into a number of super-clusters based on one or more features. The one or more features are determined based on the performance counter values, rather than from UE MRs or CHRs. The one or more features can represent coverage, interference, or user equipment characteristics of the number of network elements. Examples of the one or more features include a correlation between an interference measurement (e.g., RTWP) and a traffic measurement (e.g., the number of active UEs) of a network element, a correlation between a call drop rate and an interference measurement (e.g., RTWP) of a network element, or other features that reflect each network element's coverage, interference, and UE characteristics.

At 330, for each super-cluster, a global model representing a global relationship pattern between the performance indicator and the performance counter value is determined based on the number of sets of data points of the number of network elements. In some implementations, the global model is determined by performing a regression based on the number of sets of data points of the number of network elements. The plot 205 in FIG. 2 shows an example global model 210 determined based on all the data points 202 corresponding to all the network elements.

At 340, for each network element of the number of network elements, one or more residual features are determined. The residual features can be based on one or more error measure (e.g., the distance 204 in FIG. 2) between the global model and the set of data points that include the performance indicator and the performance counter values of the given network element.

At 350, a second layer of clustering is performed to group the number of network elements (within the considered super cluster) into a number of clusters based on the determined residual features of the number of network elements. In some implementations, the number of network elements are clustered into a number of clusters without the knowledge of or without considering UE MRs, CHRs, configuration parameters, or engineering parameters of the number of network elements.

At 360, for each of the number of clusters, a respective regression model is determined based on performance counter values and performance indicators of network elements within the cluster. For example, the plot 250 in FIG. 2 shows respective regression models 215, 220 and 230 for three clusters determined based on the sets of data points 202 of the number of network elements.

At 370, performance of a network element is predicted according to the regression model. For example, the network element's KPI value can be predicted by plugging the network's performance measurements (which can be obtained based on user input, simulation or other mechanisms) into the regression model.

In some implementations, additional or different operations can be included in the example process 300. For example, feature selection, feature normalization, cross validation, or other techniques for improving the quality of the clustering can be performed and incorporated in the example process 300.

In some implementations, example techniques for linking performance behavior to cell physics are provided, for example, to better use the cell physics features to predict network performance. For example, in some implementations, cell physics-based clustering techniques are inherited or chosen for cell clustering. To improve the accuracy of the cell physics-based clustering techniques, the relative influential or relevant cell physics features that explain or are indicative of cells' performance behaviors can be selected, for example, via one or more feature selection techniques. Various existing feature selection, such as wrappers, filters, and embedded methods can be used.

In some implementations, the feature selection is based on the clusters determined based on the performance behavior-based clustering techniques described above. For example, the clusters determined based on the performance behavior-based clustering techniques can be used as known variables and input to the feature selection algorithms to evaluate each feature's effectiveness in reflecting the network element's association with the clusters. The feature selection can be used to prevent over-fitting, to identify a smaller set of cell physics features without sacrificing modeling performance, and to find the optimal smaller set of cell physics features for cell physics-based clustering.

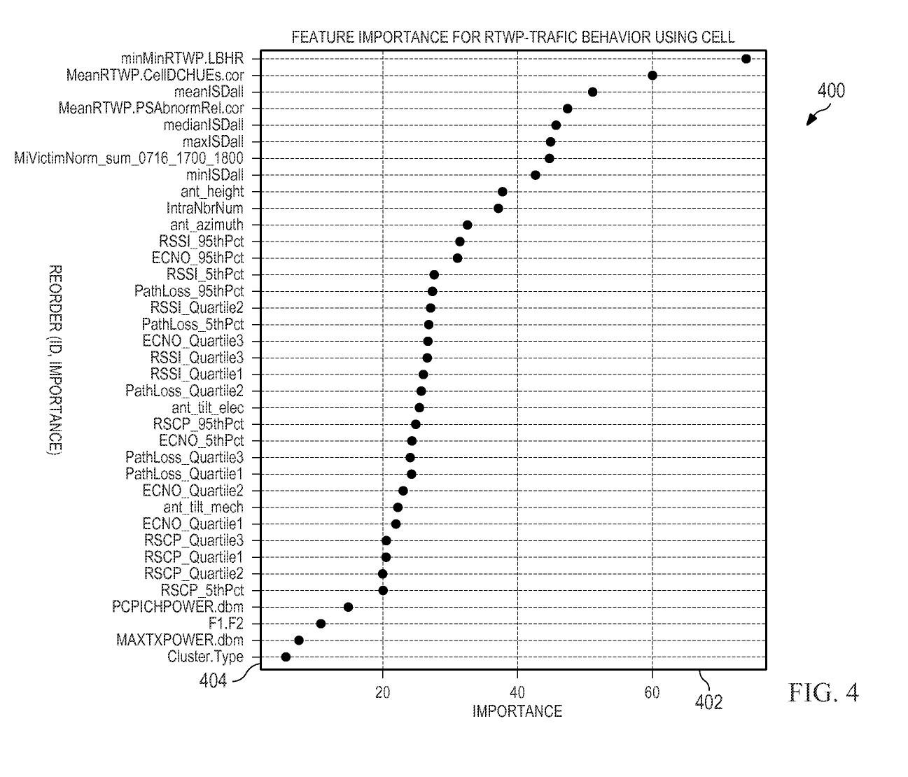

FIG. 4 is a plot diagram 400 showing example feature selection results from a Random Forest mechanism, based on clusters determined from the performance behavior-based clustering techniques. The left-hand side 404 of the diagram shows the names of cell physics features ranked in a decreasing order of relevance or importance (the x-axis 402 represents the importance score). The ranking of multiple cell physics features are obtained based on Random Forest algorithms in this example. Other feature selection algorithms can be used in other instances. As shown in FIG. 4, the minMinRTWP LBHR, which represents the noise floor of the cell, is the most relevant cell physics feature, while Cluster Type is the least relevant cell physics feature for indicating the cell's network performance behavior (e.g., the KPI-Traffic-Resource behavior as modeled using the performance behavior-based approach). In addition, a subset of, for example, the first 9 cell physics can be selected as an optimized or optimal smaller set of features to be used by the cell physics-based clustering approach to achieve a faster clustering result without sacrificing the clustering quality. Additional or different subsets of the cell physics features can be selected in other instances.

Table 1 (below) shows example results of three approaches for predicting RTWP for observations with RTWP percentage loading range >90%. The first approach uses no clustering with linear regression; the second approach uses cell physics-based clustering, and the third approach uses performance behavior-based clustering. Table 1 shows Mean Absolute Percentage Deviation (MAPD) and Goodness of Fitness (GOF) both improve significantly when clustering is introduced in the modeling process, either using cell physics-based approach or performance behavior-based approach. Moreover, the performance behavior-based clustering achieves 30% performance improvement in MAPD, particularly for poor points (which are more important and more difficult to predict), and 16% improvement in R² (a GOF statistic) over the cell physics-based clustering.

TABLE 1
Simulation Results for Predicting Network Performance

| | MAPD.POOR | MAPD.ALL | GOF (R²) |
|---|---|---|---|
| No clustering + | 10.1% | 1.30% | 0.43 |
| Linear Regression | | | |
| Cell Physics-based | 5.3% | 1.10% | 0.61 |
| Modeling | | | |
| Performance-based | 3.7% (30% | 0.98% | 0.71 (16% |
| Modeling | improvement over | | improvement over |
| | physics-based | | cell physics-based |
| | approach) | | approach) |

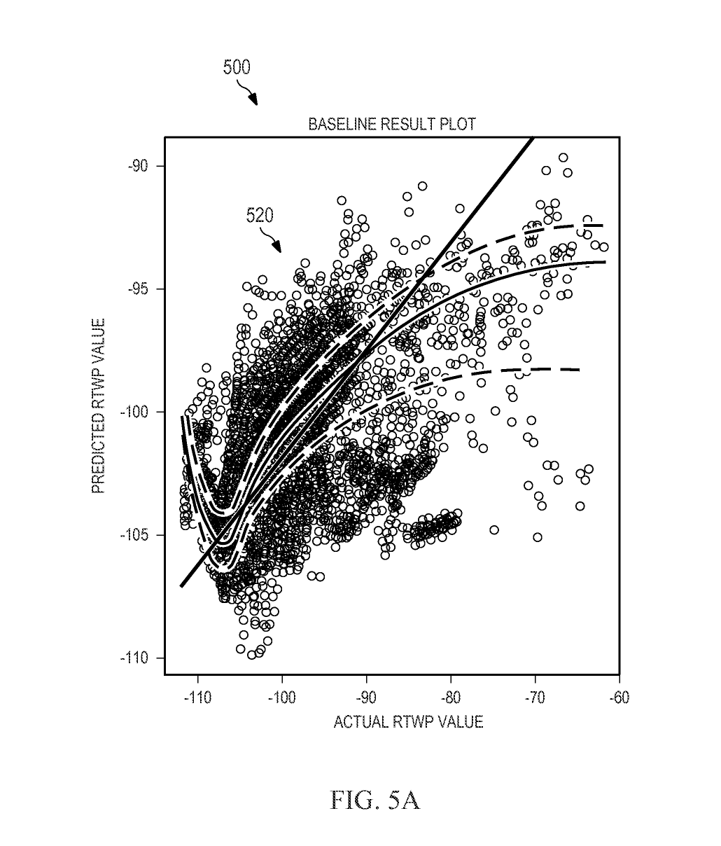

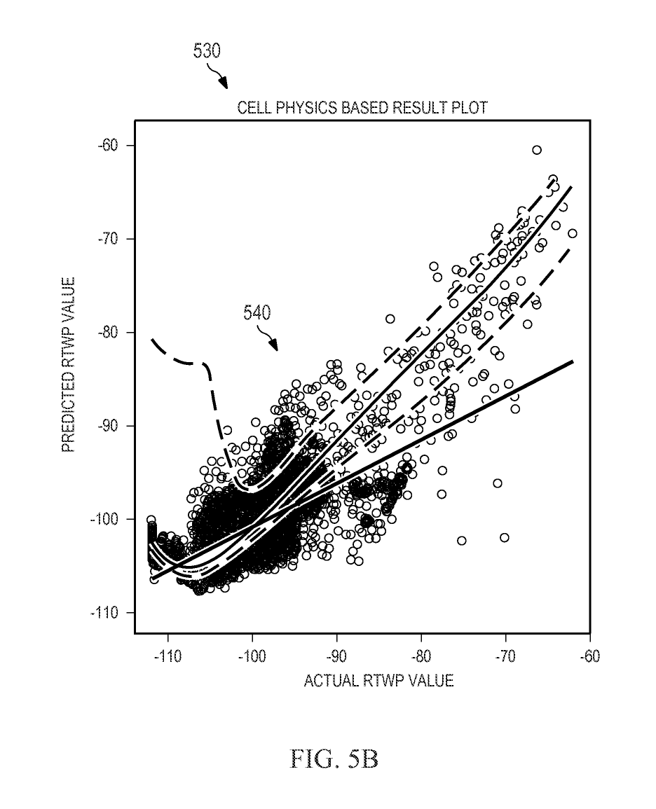

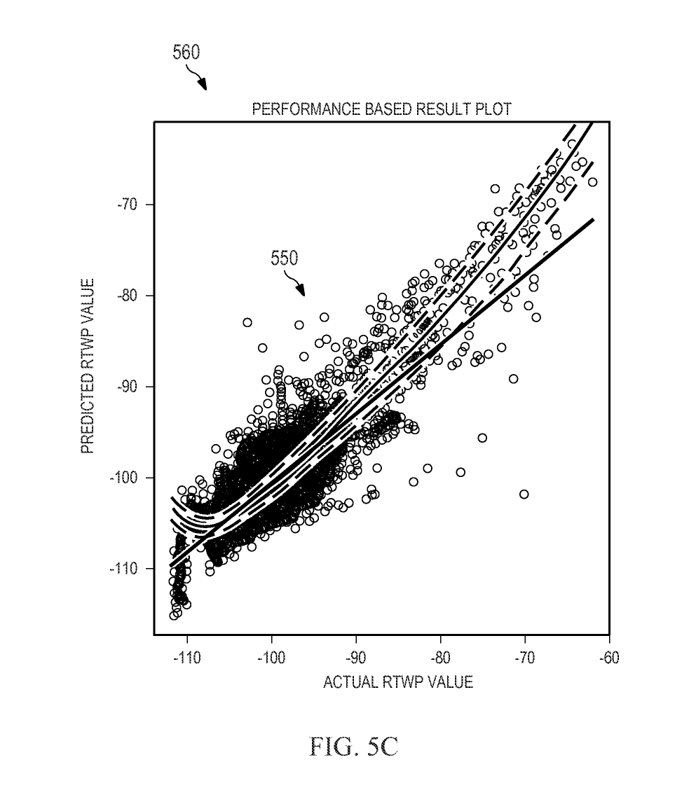

FIG. 5A is a plot 500 showing example predicted RTWP values versus actual RTWP values based on a baseline approach of linear regression without clustering procedure. FIG. 5B is a plot 530 showing example predicted RTWP values versus actual RTWP values using cell physics-based clustering. FIG. 5C is a plot 560 showing example predicted RTWP values versus actual RTWP values using performance behavior-based clustering. Ideally for perfect prediction, the data points (represented by circles 520, 540, 550) should lie along the 45 degree straight line. A smaller ellipse “thickness” of the set of data points implies lesser errors or better GOF. The comparison between FIG. 5A and FIGS. 5B-C shows that prediction power increases when applying clustering compared to no clustering (as shown in FIG. 5A). The comparison between FIG. 5B and FIG. 5C shows that performance behavior-based approach (as shown in FIG. 5C) has better predication accuracy than the cell physics-based approach (as shown in FIG. 5B).

Implementations of the subject matter and the operations described in this disclosure can be implemented in digital electronic circuitry, or in computer software, firmware, or hardware, including the structures disclosed in this disclosure and their structural equivalents, or in combinations of one or more of them. Implementations of the subject matter described in this disclosure can be implemented as one or more computer programs, i.e., one or more modules of computer program instructions, encoded on computer storage medium for execution by, or to control the operation of, a processing apparatus. Alternatively or in addition, the program instructions can be encoded on an artificially-generated propagated signal, for example, a machine-generated electrical, optical, or electromagnetic signal that is generated to encode information for transmission to suitable receiver apparatus for execution by a processing apparatus. A computer storage medium, for example, the computer-readable medium, can be, or be included in, a computer-readable storage device, a computer-readable storage substrate, a random or serial access memory array or device, or a combination of one or more of them. The computer storage medium can also be, or be included in, one or more separate physical and/or non-transitory components or media (for example, multiple CDs, disks, or other storage devices).

In some implementations, the operations described in this disclosure can be implemented as a hosted service provided on a server in a cloud computing network. For example, the computer-readable storage media can be logically grouped and accessible within a cloud computing network. Servers within the cloud computing network can include a cloud computing platform for providing cloud-based services. The terms “cloud,” “cloud computing,” and “cloud-based” may be used interchangeably as appropriate without departing from the scope of this disclosure. Cloud-based services can be hosted services that are provided by servers and delivered across a network to a client platform to enhance, supplement, or replace applications executed locally on a client computer. The system can use cloud-based services to quickly receive software upgrades, applications, and other resources that would otherwise require a lengthy period of time before the resources can be delivered to the system.

The operations described in this disclosure can be implemented as operations performed by a processing apparatus on data stored on one or more computer-readable storage devices or received from other sources. The term “processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this disclosure can be implemented on a computer having a display device, for example, a CRT (cathode ray tube) or LCD (liquid crystal display) monitor, for displaying information to the user, and a keyboard, a pointing device, for example, a mouse or a trackball, or a microphone and speaker (or combinations of them) by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this disclosure can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this disclosure, or any combination of one or more such back-end, middleware, or front-end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (for example, an HTML page) to a client device (for example, for purposes of displaying data to and receiving user input from a user interacting with the client device). Data generated at the client device (for example, a result of the user interaction) can be received from the client device at the server.

While this disclosure contains many specific implementation details, these should not be construed as limitations on the scope of any implementations or of what may be claimed, but rather as descriptions of features specific to particular implementations of particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by operation of a processing apparatus, a plurality of sets of data points of a plurality of network elements, each of the plurality of sets of data points corresponding to a respective network element of the plurality of network elements, the set of data points comprising performance counter values and a performance indicator of the respective network element;
determining, by operation of the processing apparatus, a global model representing a global relationship pattern between the performance indicator and the performance counter values based on the plurality of sets of data points of the plurality of network elements;
for each network element of the plurality of network elements, determining, by operation of the processing apparatus, one or more residual features, the one or more residual features based on error measures between the global model and the set of data points comprising the performance indicator and the performance counter values of the network element; and
clustering, by operation of the processing apparatus, the plurality of network elements into a plurality of clusters based on the determined one or more residual features of the plurality of network elements.

2. The method of claim 1, wherein the performance counter values comprise one or more of a number of active users in the network counter, a number of traffic bytes in the network, a throughput of the network, an interference level, or a downlink (DL) transmit power level.

3. The method of claim 1, wherein determining a global model representing a global relationship pattern between the performance indicator and the performance counter values based on the plurality of sets of data points of the plurality of network elements comprises performing a regression based on the plurality of sets of data points of the plurality of network elements.

4. The method of claim 1, wherein clustering the plurality of network elements into a plurality of clusters based on the determined one or more residual features of the plurality of network elements comprises clustering the plurality of network elements into a plurality of clusters without user equipment (UE) measurement reports (MRs), call history records (CHRs), configuration parameters, or engineering parameters of the plurality of network elements.

5. The method of claim 1, further comprising, prior to determining the global model, performing an additional layer of clustering by clustering the plurality of network elements into a plurality of super-clusters based on one or more features, and
wherein determining a global model comprises determining a global model for each of the plurality of super-clusters.

6. The method of claim 5, wherein the one or more features are determined based on the performance counter values and represent coverage, interference, or user equipment characteristics of the plurality of network elements.

7. The method of claim 5, wherein the one or more features comprises a correlation between an interference measurement and a traffic measurement of a network element or comprises a correlation between a call drop rate and an interference measurement of a network element.

8. The method of claim 1, further comprising, for each of the plurality of clusters, determining a respective regression model based on performance counter values and performance indicators of network elements within the cluster.

9. The method of claim 8, further comprising predicting performance of a network element according to the regression model.

10. The method of claim 8, further comprising selecting cell physics features that are indicative of network performance behavior based on the plurality of clusters and the respective regression models.

11. A computing system comprising:
a memory storing programming; and
a processor interoperably coupled with the memory and, when executing the programming, the computing system is configured to:
receive a plurality of sets of data points of a plurality of network elements, each of the plurality of sets of data points corresponding to a respective network element of the plurality of network elements, the set of data points comprising performance counter values and a performance indicator of the respective network element;
determine a global model representing a global relationship pattern between the performance indicator and the performance counter values based on the plurality of sets of data points of the plurality of network elements;
for each network element of the plurality of network elements, determine one or more residual features, the one or more residual features based on error measures between the global model and the set of data points comprising the performance indicator and the performance counter values of the network element; and
cluster the plurality of network elements into a plurality of clusters based on the determined one or more residual features of the plurality of network elements.

12. The computing system of claim 11, wherein the performance counter values comprise one or more of a number of active users in the network, a number of traffic bytes in the network, a throughput of the network, an interference level, or a downlink (DL) transmit power level.

13. The computing system of claim 11, wherein determining a global model representing a global relationship pattern between the performance indicator and the performance counter values based on the plurality of sets of data points of the plurality of network elements comprises performing a regression based on the plurality of sets of data points of the plurality of network elements.

14. The computing system of claim 11, wherein clustering the plurality of network elements into a plurality of clusters based on the determined one or more residual features of the plurality of network elements comprises clustering the plurality of network elements into a plurality of clusters without user equipment (UE) measurement reports (MRs), call history records (CHRs), configuration parameters, or engineering parameters of the plurality of network elements.

15. The computing system of claim 11, the computing system further configured to, prior to determining the global model, perform an additional layer of clustering by clustering the plurality of network elements into a plurality of super-clusters based on one or more features, and
wherein determining a global model comprises determining a global model for each of the plurality of super-clusters.

16. The computing system of claim 15, wherein the one or more features are determined based on the performance counter values and represent coverage, interference, or user equipment characteristics of the plurality of network elements.

17. The computing system of claim 15, wherein the one or more features comprises a correlation between an interference measurement and a traffic measurement of a network element or comprises a correlation between a call drop rate and an interference measurement of a network element.

18. The computing system of claim 11, the computing system further configured to, for each of the plurality of clusters, determine a respective regression model based on performance counter values and performance indicators of network elements within the cluster.

19. The computing system of claim 18, the computing system further configured to predict performance of a network element according to the regression model.

20. The computing system of claim 18, the computing system further configured to select cell physics features that are indicative of network performance behavior based on the plurality of clusters and the respective regression models.

21. A non-transitory, computer-readable medium storing computer-readable instructions executable by a computer and configured to perform operations comprising:
receiving a plurality of sets of data points of a plurality of network elements, each of the plurality of sets of data points corresponding to a respective network element of the plurality of network elements, the set of data points comprising performance counter values and a performance indicator of the respective network element;
determining a global model representing a global relationship pattern between the performance indicator and the performance counter values based on the plurality of sets of data points of the plurality of network elements;
for each network element of the plurality of network elements, determining one or more residual features, the one or more residual features based on error measures between the global model and the set of data points comprising the performance indicator and the performance counter values of the network element; and
clustering the plurality of network elements into a plurality of clusters based on the determined one or more residual features of the plurality of network elements.
